(19) United States
(12) Patent Application Publication
(10) Pub. No.: US 2006/0186650 A1
(43) Pub. Date: Aug. 24, 2006

(54) Instrument panel for vehicle, having a base which has an open cross section

(75) Inventors: Yohei Kuwano, Utsunomiya-shi (JP); Yasunori Sakamoto, Nasukarasuyama-shi (JP); Kouzou Shimamura, Shioya-gun (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/357,613

(22) Filed: Feb. 17, 2006

(30) Foreign Application Priority Data
Feb. 23, 2005 (JP) 2005-046726
Feb. 25, 2005 (JP) 2005-051623

(51) Int. Cl. B60R 21/205; B60R 21/215

(52) U.S. Cl. 280/732; 280/728.3; 180/90; 280/752

(57) ABSTRACT

An instrument panel for a vehicle, having an instrument panel base including an upper face member and a front face member which form an open cross-section structure. The upper face member extends substantially horizontally along a width of the vehicle, the front face member extends substantially vertically downward from an end of the upper face member closer to the center of an interior of the vehicle, and the instrument panel base is made of light metal, coupled with front pillars, and has a lid member for closing an opening of the base, through which an airbag is deployed, and a surface member for covering at least the lid member. Positions of easily-broken portions provided at the lid member and at the surface member are matched with each other. An impact absorbing layer made of hard resin is provided on a side of the front face member toward the interior.

### BACKGROUND OF THE INVENTION

1. Field of the Invention

The present invention relates to an instrument panel for a vehicle such as an automobile.

Priority is claimed on Japanese Patent Application No. 2005-051623, filed Feb. 25, 2005, and Japanese Patent Application No. 2005-046726, filed Feb. 23, 2005, the contents of which are incorporated herein by reference.

2. Description of the Related Art

In an instrument panel of a vehicle such as an automobile, a storage space for storing an airbag module for a front seat passenger may be provided in front of a front passenger's seat. Generally, the upper portion of the storage space for the airbag module is covered with a lid member arranged inside the instrument panel, thereby securing necessary rigidity of the instrument panel above the storage.

In an example, an easily-broken portion for easily deploying an airbag is provided in the lid member, and a similar easily-broken portion is provided in the instrument panel, so that when the airbag is deployed, the lid member and the instrument panel are broken so as to reliably deploy the air bag (see, for example, Japanese Unexamined Patent Application, First Publication No. 2001-219805).

However, in the above instrument panel, perforations or the like such as in the easily-broken portion are formed on an outer surface of the instrument panel; thus, the perforations attract the passenger's attention, thereby degrading quality of appearance.

Generally, in addition to the airbag module, devices such as various kinds of meters and audio systems are provided in the instrument panel. In addition, in order to improve the rigidity of the vehicle body, a steering hanger beam, which extends along the overall width of the vehicle, is provided in front of the instrument panel, and a steering column is attached to the steering hanger beam. In recent years, a technique for excluding (the need for) the steering hanger beam and efficiently using an inner space of the instrument panel has been developed.

Generally, the instrument panel is made of resin or the like, and the steering hanger beam is provided inside the instrument panel and is joined to front pillars on the right and left sides of the vehicle, thereby improving the rigidity of the vehicle body. The instrument panel, the steering column, the airbag module, and the like, are supported by the steering hanger beam, and an air-conditioner duct, which extends along a width of the vehicle, is provided inside the instrument panel.

As a conventional instrument panel structure, an instrument panel made of resin and having a closed cross section is known (see, for example, Japanese Unexamined Patent Application, First Publication No. H10-273072). In such an instrument panel, devices such as an air-conditioning system and an airbag are contained. In addition, a steering support bracket, supported by the vehicle body, is fastened to the instrument panel, and a steering column is fastened to the bracket.

An instrument panel structure is also known, in which an instrument panel and a steering hanger beam are provided as a single body made of resin (see, for example, Japanese Unexamined Patent Application, First Publication No. 2003-072421). In such an instrument panel, reinforcing parts are provided, in which a plurality of plates, which extend horizontally, are vertically arranged at regular intervals. The reinforcing parts function as steering hanger beams, and a steering column is inserted into an opening provided in the instrument panel, so as to support the steering column.

In recent years, enlargement of the inner space of the instrument panel has been required so as to arrange various electronic devices. As described above, the steering hanger beam, which extends along a width of the vehicle, is positioned in front of the instrument panel. Therefore, the inner space of the instrument panel cannot be effectively used.

In addition, the air-conditioner duct must be heat-insulated due to its property. However, due to a space necessary for arranging an insulating material or the like, the inner space of the instrument panel should be reduced.

### SUMMARY OF THE INVENTION

In light of the above circumstances, an object of the present invention is to provide an instrument panel for a vehicle for effectively using the inner space of the instrument panel by eliminating a steering hanger beam, and for improving the quality of appearance in the vicinity of an airbag storage space when viewed from the interior of the vehicle.

Therefore, the present invention provides an instrument panel for a vehicle, comprising:

an instrument panel base (e.g., an instrument panel structure 50 in a first embodiment explained below) having an upper face member (e.g., an upper face member 51 in the first embodiment) and a front face member (e.g., a front face member 52 in the first embodiment) which form an open cross-section structure, wherein the upper face member extends substantially horizontally along a width of the vehicle, the front face member extends substantially vertically downward from an end of the upper face member closer to the center of an interior of the vehicle, and the instrument panel base is made of light metal and is coupled with front pillars (e.g., front pillars 100a and 100b in the first embodiment) on left and right sides of the vehicle;

a lid member (e.g., a lid member 35 in the first embodiment) for closing an opening (e.g., an opening 25 in the first embodiment) formed in the instrument panel base, through which an airbag is deployed; and

a surface member (e.g., a soft resin layer 15 in the first embodiment) for covering at least the lid member, wherein:

an easily-broken portion which is more easily broken in comparison with other portions is provided on each of back faces of the lid member and the surface member, and positions of the easily-broken portion (e.g., perforations 75 in the first embodiment) provided at the lid member and the easily-broken portion (e.g., tear lines 18 in the first embodiment) provided at the surface member are matched with each other.

Preferably, the easily-broken portion provided on the back face of the surface member has intermittently-formed edges.

In accordance with the above structure, mechanical strength of the instrument panel base made of light metal can be improved. The left-side and the right-side front pillars are coupled with each other via the instrument panel base; thus, sufficient rigidity of the vehicle body can be obtained without providing a steering hanger beam.

As the steering hanger beam can be omitted, the weight of the vehicle can be reduced. In addition, the instrument panel base has an open cross-section structure; thus, various kinds of devices can be easily contained inside the instrument panel base, thereby effectively using the space.

Additionally, the airbag is deployed via the opening provided in the instrument panel base made of light metal; thus, the instrument panel base made of light metal is not affected by deployment of the airbag.

In addition, due to the lid member, necessary rigidity above the opening of the instrument panel base is secured, and when the airbag is deployed, the easily-broken portion provided at the lid member and the easily-broken portion provided at the surface member can be easily and reliably broken due to pressure of the airbag, thereby improving reliability.

Furthermore, in the surface member, the easily-broken portion is provided only on the back side of the surface member, which is invisible from the interior side of the vehicle, thereby preventing the easily-broken portion from being exposed (on a surface of the surface member) toward the interior of the vehicle. Therefore, it is possible to improve the quality of appearance in the vicinity of an airbag storage space.

The present invention also provides an instrument panel for a vehicle, comprising:

an instrument panel base (e.g., an instrument panel structure 50 in a second embodiment explained below) having an upper face member (e.g., an upper face member 51 in the second embodiment) and a front face member (e.g., a front face member 52 in the second embodiment) which form an open cross-section structure, wherein the upper face member extends substantially horizontally along a width of the vehicle, the front face member extends substantially vertically downward from an end of the upper face member closer to the center of an interior of the vehicle, and the instrument panel base is made of light metal and is coupled with front pillars (e.g., front pillars 100a and 100b in the second embodiment) on left and right sides of the vehicle, wherein:

an impact absorbing layer (e.g., a pad main body 36 in the second embodiment) made of hard resin is provided on a side of the front face member toward an interior of the vehicle.

In accordance with this structure, sufficient strength can be obtained by the instrument panel base made of light metal. The left-side and the right-side front pillars are coupled with each other via the instrument panel base; thus, sufficient rigidity of the vehicle body can be obtained without providing a steering hanger beam, thereby omitting the steering hanger beam. In addition, the instrument panel base has an open cross-section structure; thus, various kinds of devices can be easily contained inside the instrument panel base, thereby effectively using the space. Additionally, a face of the instrument panel base toward a passenger can have appropriate hardness due to the impact absorbing layer made of hard resin; thus, it is possible to prevent the passenger from directly contacting the instrument panel base, and impact can be absorbed so as to protect the passenger.

In an example, a part (e.g., an interior discharge duct 22E in the second embodiment) of an air-conditioner duct of the vehicle, which extends along a width of the vehicle, is surrounded and supported by the impact absorbing layer.

In this case, for example, a part of an air-conditioner duct arranged inside the instrument panel can be omitted; thus, the inner space of the instrument panel can be enlarged, thereby improving flexibility in arrangement of devices or the like in the inner space of the instrument panel.

In addition, heat-insulating and sound-insulating performance of the air-conditioner duct can be improved, thereby reducing a burden imposed on an air-conditioning system and improving stillness inside the interior of the vehicle. Therefore, it is possible to reduce energy consumption and to improve productivity.

In a typical example, at both ends of said part of the air-conditioner duct which is surrounded by the impact absorbing layer, joint portions (e.g., joint portions 39 in the second embodiment) are provided which are connectable to other parts (e.g., interior discharge ducts 22C and 22D in the second embodiment) of the air-conditioner duct.

In another typical example, at both ends of the impact absorbing layer for surrounding said part of the air-conditioner duct, joint portions (e.g., joint portions 39 in the second embodiment) are provided which are connectable to other parts (e.g., interior discharge ducts 22C and 22D in the second embodiment) of the air-conditioner duct.

In accordance with the above typical examples, said part of the air-conditioner duct can be easily coupled with said other parts of the air-conditioner duct; thus, it is possible to reduce a burden imposed on the operator who performs the connection of the ducts.

### BRIEF DESCRIPTION OF THE DRAWINGS

FIG. 1 is a perspective view and an assembly diagram of an instrument panel as a first embodiment in accordance with the present invention.

FIG. 2 is a perspective view of an appearance of the instrument panel, viewed from the right side in the first embodiment.

FIG. 3 is an exploded perspective view of the instrument panel in the first embodiment.

FIG. 4 is a sectional view along line A-A in FIG. 1.

FIG. 5 is an assembly perspective view showing the airbag module in the first embodiment.

FIG. 6 is a perspective view showing the lid member in the first embodiment.

FIG. 7 is a diagram for explaining tear lines provided in the soft resin layer in the first embodiment.

FIG. 8 is a diagram for detailedly explaining the tear lines of the soft resin layer in the first embodiment.

FIG. 9 is a perspective view and an assembly diagram of an instrument panel as a second embodiment in accordance with the present invention.

FIG. 10 is a perspective view showing connection between the instrument panel and a pillar in the second embodiment.

FIG. 11 is an exploded perspective view of the instrument panel in the second embodiment.

FIG. 12 is a sectional view along line A-A in FIG. 9.

FIGS. 13A to 13C are sectional views along line B-B in FIG. 12.

### DETAILED DESCRIPTION OF THE INVENTION

Hereinafter, embodiments according to the present invention will be described with reference to the appended figures.

In the embodiments explained below, a vehicle having a left-hand steering wheel is employed as an example, in which a driver's seat and a front passenger's seat are respectively arranged on left and right sides of the vehicle with respect to the traveling direction.

### First Embodiment

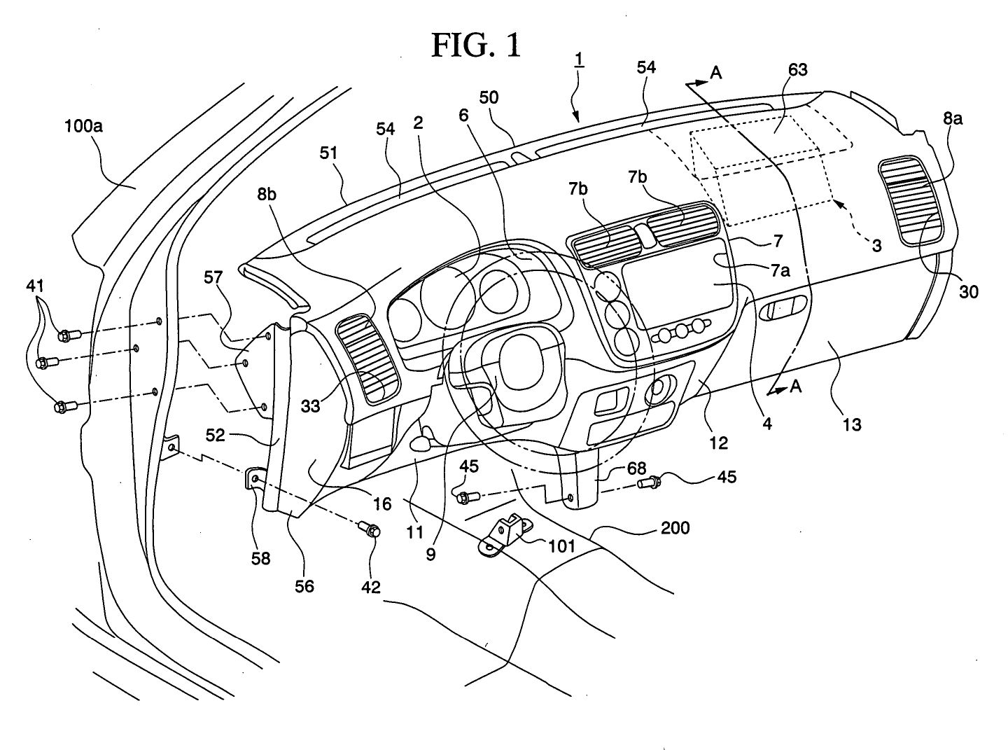

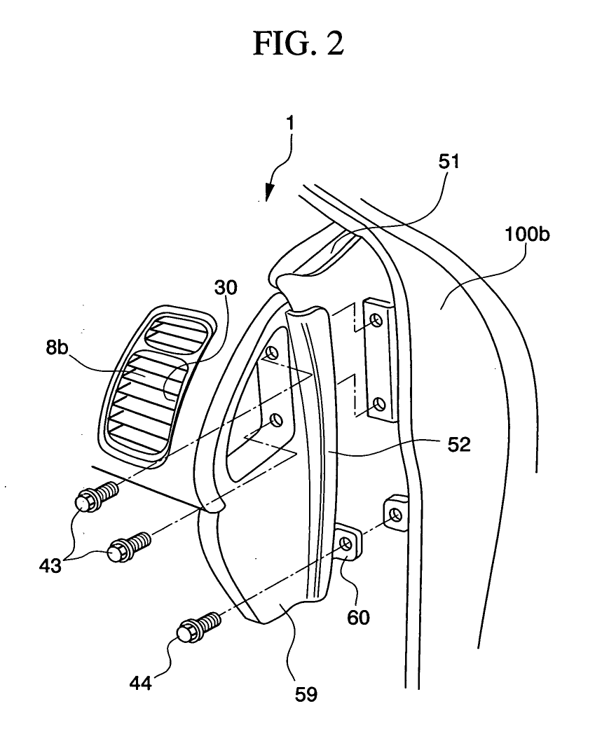

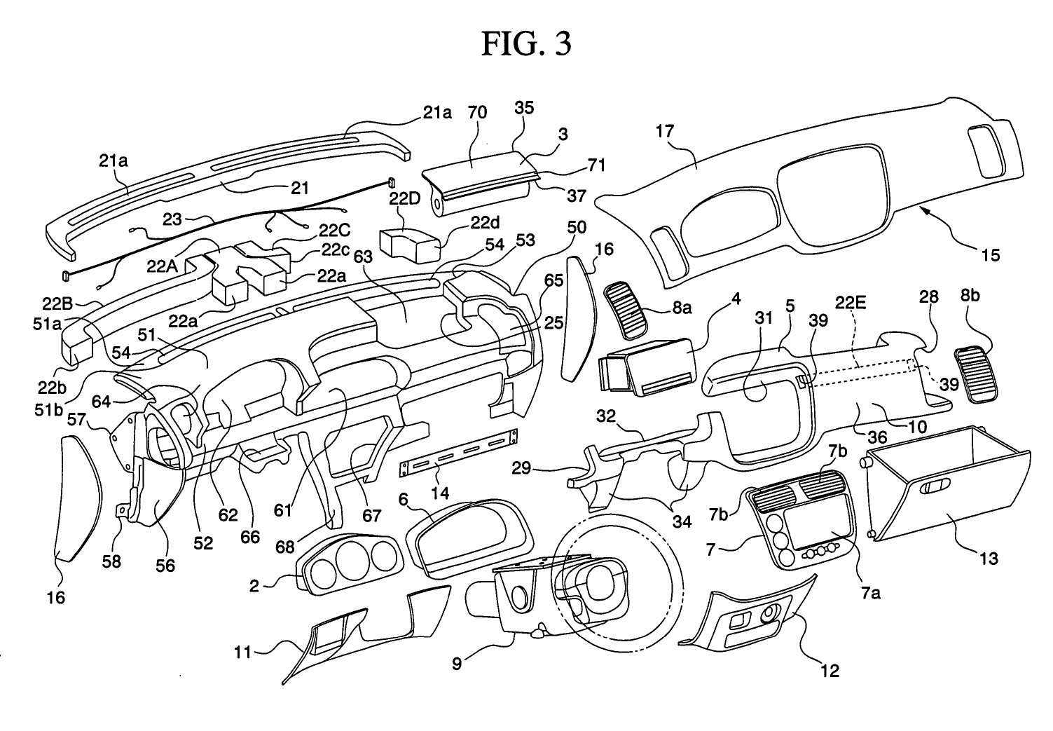

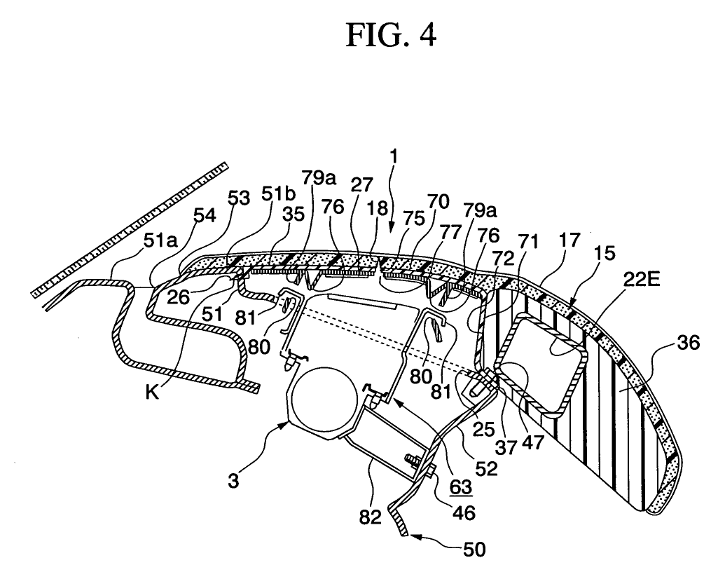

FIG. 1 is a perspective view and an assembly diagram of an instrument panel as a first embodiment in accordance with the present invention. FIG. 2 is a perspective view of an appearance of the instrument panel, viewed from the right side. FIG. 3 is an exploded perspective view of the instrument panel. FIG. 4 is a sectional view along line A-A in FIG. 1.

As shown in FIGS. 1 to 4, an instrument panel 1 is provided in the interior of a vehicle while adjoining a front windowpane of the vehicle, and the instrument panel 1 is arranged in front of the driver's and the front passenger's seats along the overall width of the vehicle. The left and right ends of the instrument panel 1 are respectively fastened to front pillars 100a and 100b by bolts 41 to 44.

The instrument panel 1 has an instrument panel structure 50 (i.e., an instrument panel base) which is made of magnesium alloy (i.e., light alloy) and is integrally molded by die-cast molding. A meter unit 2, an airbag module 3, an audio and heater control unit 4 (simply called the “audio unit”, hereinbelow), a steering column 9, and a glove box (or compartment) 13, and the like, are attached to the instrument panel structure 50.

The instrument panel structure 50 consists of an upper face member 51 and a front face member 52 which form an open cross-section structure. The upper face member 51 extends substantially horizontally along a width of the vehicle, and the front face member 52 extends substantially vertically downward from an end (closer to the center of the interior of the vehicle) of the upper face member 51. Therefore, various devices can be contained inside the instrument panel structure 50, thereby effectively using the space.

The upper face member 51 has a step portion 53 which expands upward and is arranged along the overall width of the vehicle. In a lower step portion 51a positioned in front of the step portion 53 (i.e., closer to the front of the vehicle), long and narrow front-defroster blowout holes 54 are formed in an area along a width of the vehicle. An upper step portion 51b, positioned closer to the back of the vehicle in comparison with the lower step portion 51a, has a specific curved cross-section shape.

A side wall member 56 having a substantially-arch-shaped rear end, a bracket 57 extending frontward, and a bracket 58 extending outward along a width (direction) of the vehicle are provided at the left end of the front face member 52. A side wall member 59 having a substantially-arch-shaped rear end, and a bracket 60 extending outward along a width of the vehicle are provided at the right end of the front face member 52.

As shown in FIG. 1, the brackets 57 and 58 on the left side are respectively fastened to the left-side front pillar 100a using the bolts 41 and 42, while as shown in FIG. 2, the side wall member 59 and the bracket 60 on the right side are respectively fastened to the right-side front pillar 100b using the bolts 43 and 44.

At the center, substantially, along a width of the vehicle in an upper portion of the front face member 52, an air blowout hole 61 is open toward the back of the vehicle. On the left side of the air blowout hole 61, a meter storing recess 62 is provided, and on the right side of the air blowout hole 61, an airbag storage space 63 (which opens upward) for storing an airbag module 3 is provided. Additionally, in an upper portion of the front face member 52, an air blowout hole 64 is provided on the left side of the meter storing recess 62, and an air blowout hole 65 is provided on the right side of the airbag storage space 63.

Also in the front face member 52, (i) a steering column support table 66 is provided below the meter storing recess 62, where the table 66 is inclined at a specific angle, (ii) below the air blowout hole 61, an audio unit attachment frame 67 is vertically provided, which extends downward, and (iii) a stay 68 is vertically provided, which extends downward from the left end of the audio unit attachment frame 67.

The lower end of the stay 68 is fastened using bolts 45 to a support 101 attached to a vehicle body frame 200. That is, the right and the left ends of the instrument panel structure 50 are respectively joined to the front pillars 100a and 100b, and a lower and center portion of the instrument panel structure 50 is joined to the vehicle body frame 200.

In the instrument panel structure 50, the meter unit 2 having a speedometer or the like is stored and fixed in the meter storing recess 62, the airbag module 3 is stored and fixed in the airbag storage space 63, and the audio unit 4 is attached to the audio unit attachment frame 67.

In addition, a specific surface (which faces the inside of the interior of the vehicle) of the front face member 52 of the instrument panel structure 50 is covered with an instrument panel pad 5.

On the right side of the instrument panel pad 5, a U-shaped portion 28 is formed, which functions as a part of a grille opening 30 (see FIG. 1), and an impact absorbing portion 10, arranged toward the center along the width of the vehicle, is integrally joined to the U-shaped portion 28. The impact absorbing portion 10 is arranged in front of the front passenger's seat. An upper edge of the impact absorbing portion 10 functions as a part of a side of the airbag storage space 63 toward the back of the vehicle, and a lower edge of the impact absorbing portion 10 functions as an upper wall of the glove box 13.

A center panel opening 31 having a substantially encircling form, is integrally joined to the left side of the impact absorbing portion 10. A knee bolster support 32 extends from a lower-left portion of the center panel opening 31 toward the left side of the vehicle. The left end of the knee bolster support 32 has an L-shaped portion 29 which forms a lower corner of a grille opening 33 provided on the left side of the vehicle. To a lower-left portion and a lower-right portion of the knee bolster support 32, knee bolsters 34 are integrally joined, which extend downward.

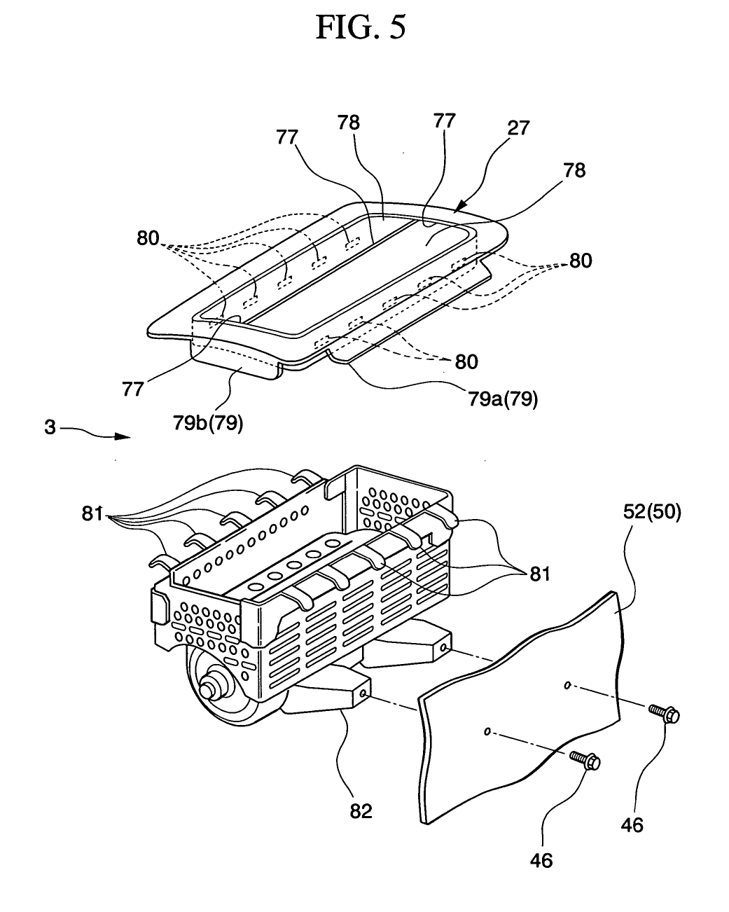

FIG. 5 is an assembly perspective view showing the airbag module 3.

As shown in FIGS. 4 and 5, to an opening 25 of the airbag storage space 63 of the instrument panel structure 50, a lid member 35 made of resin is attached so as to cover the airbag module 3. The lid member 35 consists of an upper wall 70 which is continuously joined to the upper step portion 51b of the upper face member 51, and a back wall 71 bending and extending downward from the back side of the upper wall 70. The lid member 35 is fixed using fastening hooks 26 on the front side and bolts 47 on the back side in a manner such that the opening 25 of the airbag storage space 63 is closed by the lid member 35.

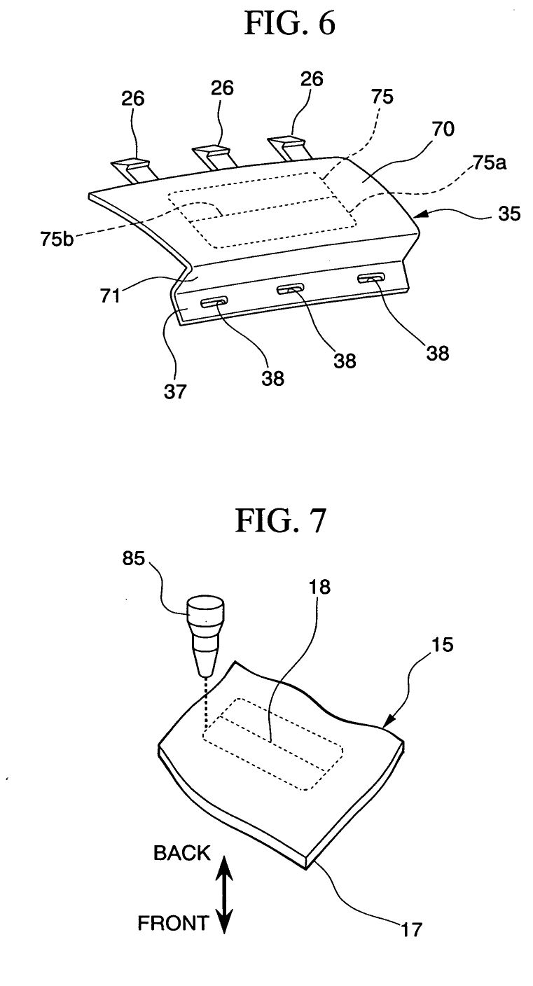

FIG. 6 is a perspective view showing the lid member 35. As shown in FIG. 6, in the lid member 35, a flange portion 37 is provided at the lower edge of the back wall 71. The flange portion 37 has three attachment (long) holes 38, into which the above-described bolts 47 are inserted so that the lid member 35 is attached to the instrument panel structure 50. At the front edge of the lid member 35, the three fastening hooks 26 are provided, which are inserted into fitting holes K formed in the instrument panel structure 50 so as to fix the lid member 35.

In the upper wall 70 of the lid member 35, perforations 75 (i.e., an easily-broken portion) passing through the upper wall 70 are formed by a laser beam machine 73 (explained later). The perforations 75 consist of a rectangular portion 75a as a peripheral line, and a cross portion 75b by which the rectangular portion 75a is divided into two front and back sections.

To a back face of the lid member 35, an upper surface portion of a hinge bracket 27 which is provided at the airbag module 3 is fixed by ultrasonic welding. In the upper surface portion of the hinge bracket 27, front and back mechanical hinge portions 76 are formed, which include downward-bending portions along the width of the vehicle. A slit 77 is formed between the mechanical hinge portions 76. Both ends of the slit 77 extend to the positions of both ends of the mechanical hinge portions 76, so that in the upper face of the hinge bracket 27, front and back door leaves 78 are formed which vertically open and close.

The hinge bracket 27 has the above-described upper surface portion welded to the back face of the lid member 35, and four extensions 79 which extend downward from the back face of the upper surface portion. The extensions 79 consist of extensions 79a on the front and back sides, and extensions 79b on the right and left sides. Each extension 79a has a plurality of fitting holes 80 (five holes in the present embodiment) to which the airbag module 3 is attached in a hung form.

Specifically, a plurality of tongue portions 81 bending downward are formed at each of the front and the back walls of the airbag module 3, and the tongue portions 81 are inserted from the lower side of the hinge bracket 27 into the fitting holes 80 of the corresponding extension 79a, thereby supporting the airbag module 3. In addition, from the lower back side of the airbag module 3, two attachment brackets 82 extend toward the back of the vehicle, which are fastened to the back side of the front face member 52 using bolts 46.

An upper face of the upper wall 70 of the lid member 35 and a face (which faces the interior of the vehicle) of the upper face member 51 of the instrument panel structure 50 are covered with a soft resin layer 15 made of soft resin (e.g., soft urethane), and a surface layer 17 is further deposited on a surface of the soft resin layer 15, which faces the interior of the vehicle.

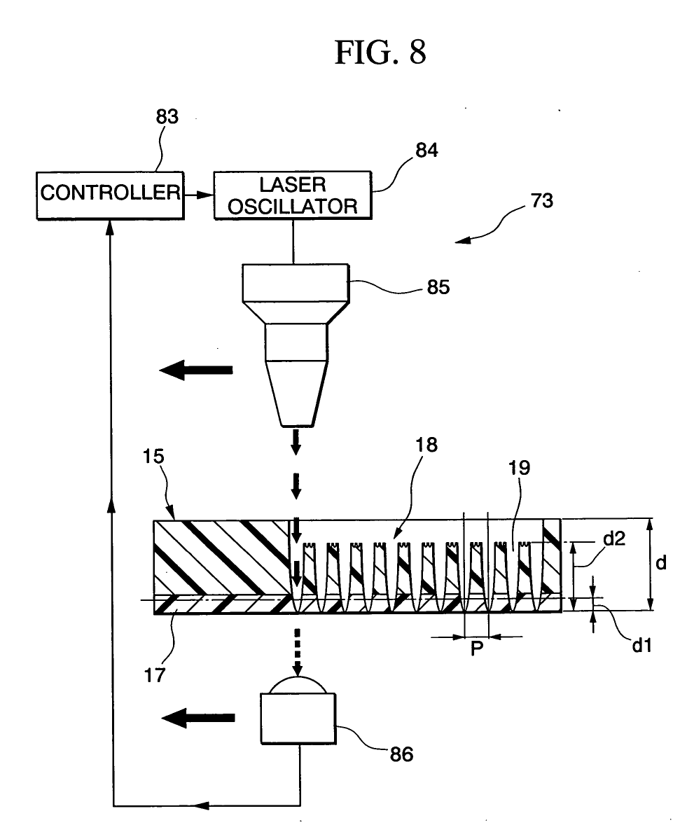

As shown in FIGS. 7 and 8, this soft resin layer 15 includes edge portions 19 corresponding to the position of the door leaves by the slits 77 of the hinge bracket 27, which are notches almost reaching the surface (which faces the interior of the vehicle) of the surface layer 17 and are formed using the laser beam machine 73. More specifically, as shown in FIG. 7, the edge portions 19 are formed at positions corresponding to the periphery of each door leaf 78 by using the laser beam machine 73 in a manner such that the depth of processing (i.e., the notches) is regularly varied, so as to produce tear lines 18 (i.e., an easily-broken portion).

In processing of the soft resin layer 15 by using the laser beam machine 73, a laser beam is emitted from an emission nozzle 85 of a laser oscillator 84 based on a signal from a controller 83, and simultaneously, the laser beam transmitted through the soft resin layer 15 is detected by a light receptor 86 so as to perform feedback control. In processing of the soft resin layer 15 having a depth “d”, a deep notch with a focal position d1 of the laser beam and a shallow notch with a focal position d2 (for emitting the laser beam at a shallower position) are alternately formed by control using the controller 83 so that notches are intermittently formed with a pitch “p” along dashed lines shown in FIG. 7. Among the tear lines 18 indicated by the dashed lines, notches formed along the peripheral tear lines 18 are not shown in FIG. 4.

As shown in FIGS. 3 and 4, the instrument panel pad 5 is positioned on the back side of the lid member 35. The instrument panel pad 5 has a pad main body 36 made of hard resin (e.g., hard urethane) having high impact-absorbing performance. The surface (which faces the interior of the vehicle) of the pad main body 36 has a curved form in which the closer it is to the back, the lower the height of the pad main body 36.

In an upper portion of the pad main body 36 (i.e., on a side toward the lid member 35), an interior discharge duct 22E for discharging air toward the interior of the vehicle is embedded between the center panel opening 31 and the grille opening 30 along a width of the vehicle. A vertical wall 72 on the front side of the pad main body 36 contacts the back wall 71 of the lid member 35, and a lower-front portion of the pad main body 36 is supported by the upper face member 51 of the instrument panel structure 50.

A front defroster duct 21, interior discharge ducts 22A to 22C, a harness 23, and the like, are arranged inside the instrument panel structure 50, that is, below the upper face member 51 and on the front side of the front face member 52.

Two blowout openings 21a of the front defroster duct 21 are joined to the corresponding front-defroster blowout holes 54. Air processed by an air conditioning unit (not shown) can be supplied to the front defroster duct 21 and the interior discharge ducts 22A to 22E. In the present embodiment, the front defroster duct 21 and the interior discharge ducts 22A to 22E are constituents of an air conditioning system of the vehicle.

Two center blowout openings 22a of the interior discharge duct 22A are disposed in an air blowout hole 61 of the instrument panel structure 50, and a blowout opening 22b of the interior discharge duct 22B is disposed in an air blowout hole 64 of the instrument panel structure 50.

The interior discharge duct 22C is connected to one of joint portions 39 of the interior discharge duct 22E, and the interior discharge duct 22D is connected to the other joint portion 39. A blowout opening 22d of the interior discharge duct 22D is disposed in an air blowout hole 65 of the instrument panel structure 50.

A meter visor 6 is inserted and fixed in the meter storing recess 62, and the meter unit can be observed through the meter visor 6. A center panel 7 is inserted and fixed in the center panel opening 31. An operation face of the audio unit 4 is fit to an opening 7a of the center panel 7, and the air blowout hole 61 of the instrument panel structure 50 is connected to grilles 7b of the center panel 7. Grilles 8a and 8b are respectively fastened to the grille openings 30 and 33.

The steering column 9 is fastened to the steering column support table 66 of the instrument panel structure 50.

In the instrument panel structure 50, a driver-seat lower cover 11 is attached to a lower portion of the steering column support table 66, and a center lower cover 12 is attached to a lower portion of the audio unit attachment frame 67. In addition, the glove box 13 is rotatably attached to a lower portion of the airbag storage space 63 at the front face member 52 of the instrument panel structure 50, and a glove box frame 14 is also attached to the lower portion of the airbag storage space 63.

In addition, instrument panel side covers 16 are attached to side wall members 56 and 59 on the right and the left sides of the front face member 52.

In accordance with the above-described embodiment, the instrument panel structure 50 is integrally molded using light metal, thereby improving mechanical strength. This instrument panel structure 50 is coupled with the left-side front pillar 100a and the right-side front pillar 100b, so that sufficient rigidity of the vehicle body can be secured even when a steering hanger beam (which is necessary in conventional structures) is omitted.

In addition, the steering column 9 is directly fastened to the steering column support table 66 of the instrument panel structure 50, thereby omitting the steering hanger beam. Therefore, the weight of the vehicle can be reduced, and various kinds of devices can be contained in an inner space of the instrument panel structure 50, thereby effectively using the space. As described above, the instrument panel structure 50 has high mechanical strength; thus, no problem occurs when supporting the steering column 9.

Additionally, an airbag can be deployed via the opening 25 of the instrument panel structure 50; thus, no force for deploying the airbag is applied to the instrument panel structure 50, which is integrally molded. That is, the instrument panel structure 50 is not affected by deployment of the airbag.

Furthermore, a face of the instrument panel 1, which is exposed toward the interior of the vehicle, is uniformly covered with the soft resin layer 15, thereby securing continuity between exposed faces of the instrument panel pad 5 and the instrument panel structure 50. In addition, the surface of the instrument panel 1, which faces the interior of the vehicle, feels soft, thereby improving the texture of the instrument panel 1.

In addition, the lid member 35 can be attached to the instrument panel structure 50 by only inserting the fastening hooks 26 of the lid member 35 into the fitting holes K and fastening the flange portion 37 by using the bolts 47. Therefore, it is possible to reduce the number of steps for attaching the lid member 35 and thus reduce a burden imposed on the worker or operator. In addition, the opening 25 of the airbag storage space 63 can be closed by the lid member 35 so as to secure necessary rigidity.

The arrangement position of the perforations 75 formed in the lid member 35 correspond to that of the tear lines 18. Therefore, when the airbag is going to be deployed and the door leaves 78 of the hinge bracket 27 are going to open due to pressure applied from the deploying airbag, the pressure from the airbag can be efficiently applied to the perforations 75 of the lid member 35 and the tear lines 18 of the soft resin layer 15, where the arrangement positions of the perforations 75 and the tear lines 18 correspond to the position of the door leaves 78 by the slits 77. Accordingly, the perforations 75 and the tear lines 18 can be easily broken, thereby immediately opening the door leaves 78.

On the back side of the soft resin layer 15, the intermittent edge portions 19 are formed as the tear lines 18; thus, the tear lines 18 are invisible from the interior side of the vehicle, thereby improving the quality of appearance in the vicinity of the airbag storage space 63 in the instrument panel 1. In addition, a breaking limit of the tear lines 18 can be freely changed by only changing a pitch p of the intermittent edge portions 19, thereby improving flexibility of design.

The intermittent edge portions 19 can be formed by changing the focal length of the laser beam from the beam machine 73 while performing feedback control using the light receptor 86. Therefore, the tear lines 18, which do not pass through the soft resin layer 15, can be easily and reliably formed.

### Second Embodiment In the second embodiment explained below, parts corresponding to those in the first embodiment are given identical reference numbers, and explanations thereof are partially omitted.

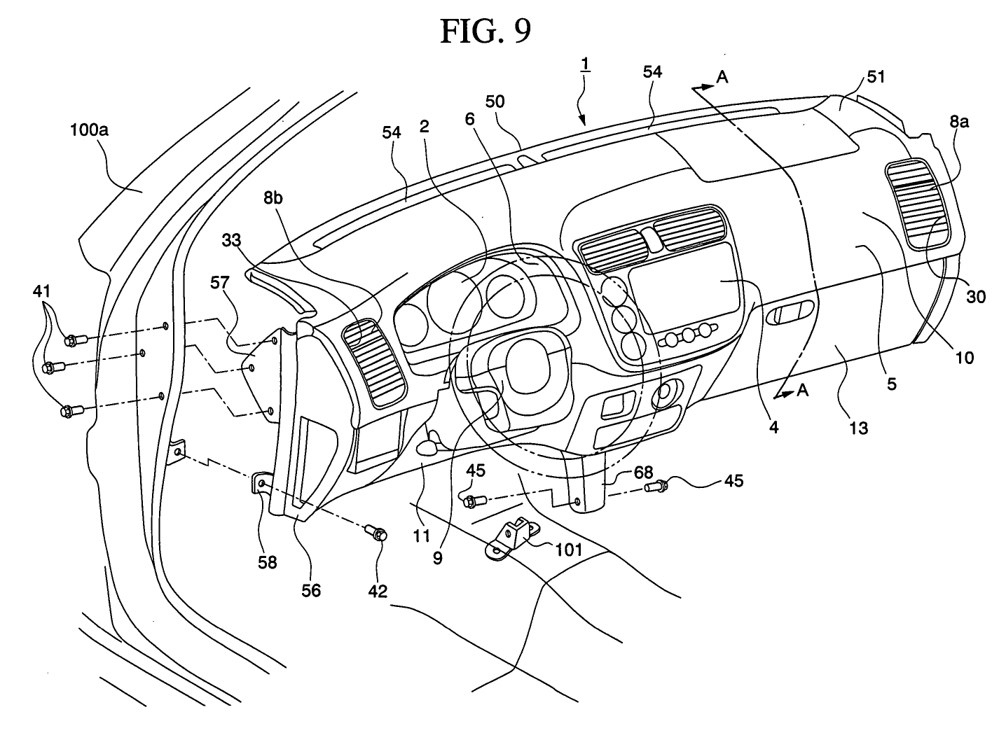

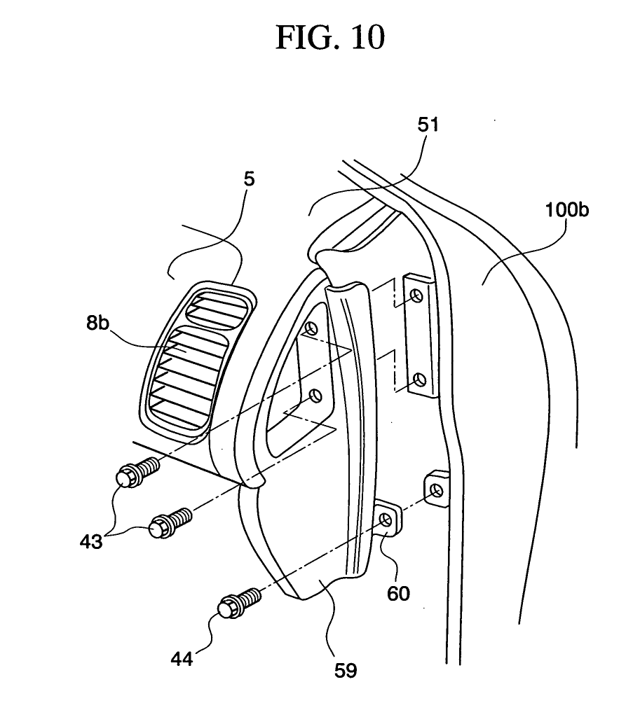

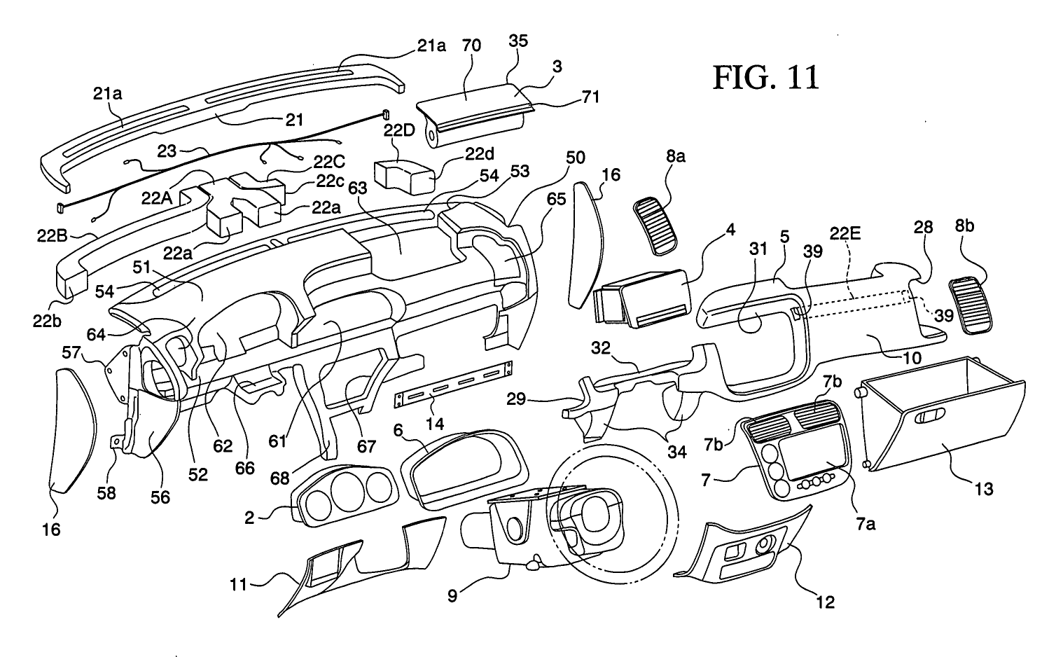

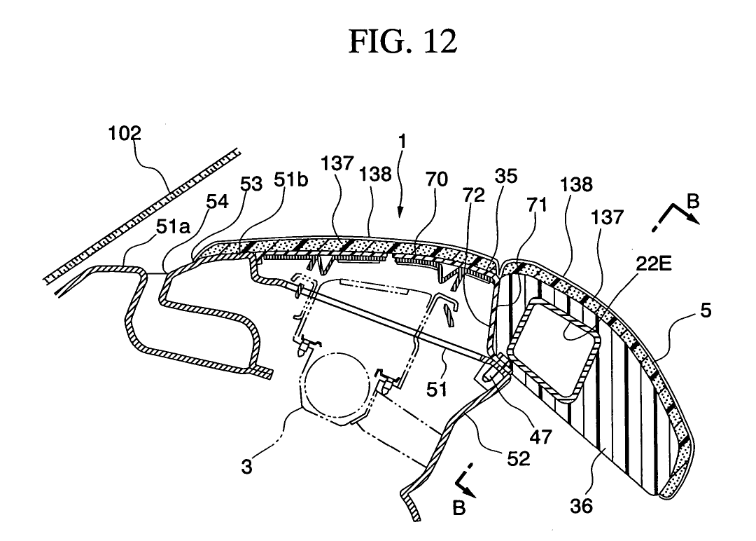

FIG. 9 is a perspective view and an assembly diagram of an instrument panel as the second embodiment in accordance with the present invention. FIG. 10 is a perspective view showing the connection between the instrument panel and a pillar. FIG. 11 is an exploded perspective view of the instrument panel. FIG. 12 is a sectional view along line A-A in FIG. 9.

As shown in FIGS. 9 to 12, the instrument panel 1 is provided in the interior of a vehicle while adjoining a front windowpane 102 of the vehicle, and is arranged in front of the driver's and front passenger's seats along the overall width of the vehicle. The left and right ends of the instrument panel 1 are respectively fastened to the front pillars 100a and 100b by the bolts 41 to 44.

The instrument panel structure 50 consists of the upper face member 51 and the front face member 52 which form an open cross-section structure. The upper face member 51 extends substantially horizontally along a width of the vehicle, and the front face member 52 extends substantially vertically downward from the upper face member 51.

As shown in FIGS. 11 and 12, similarly to the first embodiment, the lid member 35 made of resin is attached to the airbag storage space 63 of the instrument panel structure 50 so as to cover the airbag module 3, and the instrument panel pad 5 is arranged on the back side of the lid member 35. In an upper portion of the pad main body 36 (which is similar to that in the first embodiment) of the instrument panel pad 5, the interior discharge duct 22E (i.e., an air-conditioner duct) is embedded, as in the first embodiment. The vertical wall 72 on the front side of the pad main body 36 contacts the back wall 71 of the lid member 35, and a lower-front portion of the pad main body 36 is supported by the upper face member 51 of the instrument panel structure 50. The bolts 47 are used for fastening the lid member 35 to the upper face member 51.

The upper wall 70 of the lid member 35 is continuously joined to an upper face of the pad main body 36, and upper faces of the instrument panel structure 50, the lid member 35, and the pad main body 36 are uniformly covered with a soft resin layer 137 (e.g., a soft urethane layer or a P.E.F. (Performance Enhancing Film) layer), and a surface layer 138 is further deposited on a surface of the soft resin layer 137. Therefore, the instrument panel pad 5 consists of the pad main body 36, the soft resin layer 137, and the surface layer 138. The pad main body 36 made of hard resin has lower hardness and higher impact absorbing performance in comparison with the instrument panel structure 50 made of light metal.

The two center blowout openings 22a of the interior discharge duct 22A are disposed in the air blowout hole 61 of the instrument panel structure 50, and the blowout opening 22b of the interior discharge duct 22B is disposed in the air blowout hole 64 of the instrument panel structure 50. The interior discharge duct 22C is connected to one of the joint portions 39 of the interior discharge duct 22E, and the interior discharge duct 22D is connected to the other joint portion 39. The blowout opening 22d of the interior discharge duct 22D is disposed in the air blowout hole 65 of the instrument panel structure 50.

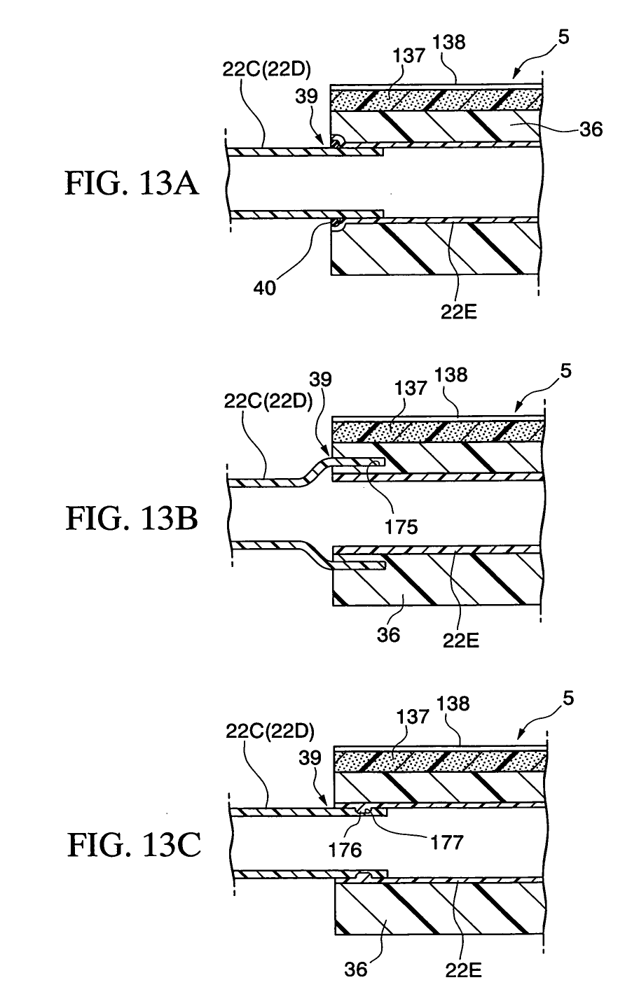

Below, the joint portions 39 will be explained with reference to FIGS. 13A to 13C. For convenience of explanation, in FIGS. 13A to 13C, only one of the joint portions 39 is shown, and the other joint portion 39 having the same form as said one of the joint portions 39 is not shown.

As shown in FIG. 13A, the joint portions 39 are provided at both ends of the interior discharge duct 22E, where urethane seal 40 is provided at each joint portion 39. Into the joint portions 39, open ends of the interior discharge ducts 22C and 22D are inserted, and the interior discharge ducts 22C and 22D are connected to the interior discharge duct 22E while the connected portions are sealed by the urethane seals 40.

FIG. 13B shows another example of the joint portions 39, in which circular grooves 175 are formed in both ends of the pad main body 36, that is, outside the interior discharge duct 22E. Into the circular grooves 175, open ends of the interior discharge ducts 22C and 22D are inserted, and the interior discharge ducts 22C and 22D are connected to the interior discharge duct 22E.

FIG. 13 C shows another example of the joint portions 39, in which circular protrusions 176 are formed in both ends of the inner periphery of the interior discharge duct 22E, and fitting grooves 177 are provided around outer peripheries of open ends of the interior discharge ducts 22C and 22D. Into the open ends of the interior discharge duct 22E, the open ends of the interior discharge ducts 22C and 22D are inserted, and the protrusions 176 of the interior discharge duct 22E are fit to the fitting grooves 177 of the interior discharge ducts 22C and 22D, so that the interior discharge ducts 22C and 22D are connected to the interior discharge duct 22E.

In the above structure, when the interior discharge ducts 22C and 22D are connected to the interior discharge duct 22E, the operator can reliably confirm that the protrusions 176 are fit to the fitting grooves 177. The above-described joint portions 39 are only an example, and various other examples are possible. For example, flange portions may be provided instead of the joint portions 39 (of the pad main body 36), the flange portions being connected to flange portions provided at the interior discharge ducts 22C and 22D.

Therefore, also in the present embodiment, the instrument panel structure 50 is integrally molded using light metal, thereby improving mechanical strength. This instrument panel structure 50 is coupled with the left-side front pillar 100a and the right-side front pillar 100b, so that sufficient rigidity of the vehicle body can be secured even when a steering hanger beam (which is necessary in conventional structures) is omitted.

In addition, the steering column 9 is directly fastened to the steering column support table 66 of the instrument panel structure 50, thereby omitting the steering hanger beam. Therefore, the weight of the vehicle can be reduced. As described above, the instrument panel structure 50 has high mechanical strength; thus, no problem occurs when supporting the steering column 9.

Furthermore, the instrument panel pad 5 consisting of the pad main body 36 and the soft resin layer 137 is provided on a side of the front face member 52 of the instrument panel structure 50 toward the interior of the vehicle. Therefore, it is possible to prevent a passenger from directly contacting the instrument panel structure 50 made of light alloy such as magnesium alloy. In addition, impact can be absorbed by the pad main body 36 made of hard resin and the soft resin layer 137 in turn, so as to protect the passenger.

In addition, the soft resin layer 137 is uniformly formed on a face of the instrument panel 1 which is exposed toward the interior of the vehicle, thereby securing continuity between exposed faces of the instrument panel pad 5 and the instrument panel structure 50. Additionally, the surface of the instrument panel 1, which faces the interior of the vehicle, feels soft, thereby improving the texture of the instrument panel 1.

The instrument panel structure 50 is manufactured by die-cast molding; thus, the instrument panel structure 50 having a complex structure can be precisely and easily manufactured.

In addition, the interior discharge duct 22E is embedded in the pad main body 36 of the instrument panel pad 5; thus, it is unnecessary to arrange an air-conditioner duct on the front side of the instrument panel structure 50. Therefore, it is possible to improve flexibility in arrangement of devices in the inner space of the instrument panel 1.

The interior discharge duct 22E is surrounded by hard resin, thereby improving heat-insulating performance for air-conditioned blow which passes through the interior discharge duct 22E. Therefore, it is possible to reduce a burden imposed on an air-conditioner unit of the vehicle and to reduce fuel consumption, and it is also possible to prevent dew condensation around the interior discharge duct 22E.

In addition, sound produced when the air-conditioned blow from the air-conditioner unit flows through the interior discharge duct 22E can be absorbed by the pad main body 36 made of hard resin and the soft resin layer 137, thereby sound-insulating the interior of the vehicle and improving stillness inside the interior.

Furthermore, ends of the interior discharge ducts 22C and 22D can be easily joined and connected to both ends of the interior discharge duct 22E via the joint portions 39, thereby reducing a burden on the operator who performs the connection of the ducts.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the instrument panel may be made of light metal other than magnesium alloy, specifically, aluminum alloy. In addition, the interior discharge duct 22E may be omitted, and a passage inside the pad main body 36 itself may be used as a duct.

In the first embodiment, the tear lines may be provided by forming intermittent edge portions not in the soft resin layer but in the lid member.

What is claimed is:

1. An instrument panel for a vehicle, comprising:
an instrument panel base having an upper face member and a front face member which form an open cross-section structure, wherein the upper face member extends substantially horizontally along a width of the vehicle, the front face member extends substantially vertically downward from an end of the upper face member closer to the center of an interior of the vehicle, and the instrument panel base is made of light metal and is coupled with front pillars on left and right sides of the vehicle;
a lid member for closing an opening formed in the instrument panel base, through which an airbag is deployed; and
a surface member for covering at least the lid member, wherein:
an easily-broken portion which is more easily broken in comparison with other portions is provided on each of back faces of the lid member and the surface member, and positions of the easily-broken portion provided at the lid member and the easily-broken portion provided at the surface member are matched with each other.

2. The instrument panel in accordance with claim 1, wherein the easily-broken portion provided on the back face of the surface member has intermittently-formed edges.

3. An instrument panel for a vehicle, comprising:
an instrument panel base having an upper face member and a front face member which form an open cross-section structure, wherein the upper face member extends substantially horizontally along a width of the vehicle, the front face member extends substantially vertically downward from an end of the upper face member closer to the center of an interior of the vehicle, and the instrument panel base is made of light metal and is coupled with front pillars on left and right sides of the vehicle, wherein:
an impact absorbing layer made of hard resin is provided on a side of the front face member toward an interior of the vehicle.

4. The instrument panel in accordance with claim 3, wherein a part of an air-conditioner duct of the vehicle, which extends along a width of the vehicle, is surrounded and supported by the impact absorbing layer.

5. The instrument panel in accordance with claim 4, wherein at both ends of said part of the air-conditioner duct which is surrounded by the impact absorbing layer, joint portions are provided which are connectable to other parts of the air-conditioner duct.

6. The instrument panel in accordance with claim 4, wherein at both ends of the impact absorbing layer for surrounding said part of the air-conditioner duct, joint portions are provided which are connectable to other parts of the air-conditioner duct.
